(19) United States
(12) Patent Application Publication
(10) Pub. No.: US 2025/0136410 A1
(43) Pub. Date: May 1, 2025

(54) ELEVATOR SAFETY SYSTEM, ELEVATOR SYSTEM, AND METHOD FOR CONTINUING OPERATION OF ELEVATOR SYSTEM AFTER MALFUNCTION OR FAILURE

(71) Applicant: KONE Corporation, Helsinki (FI)

(72) Inventors: Asmo Tenhunen, Helsinki (FI); Juha-Matti Aitamurto, Helsinki (FI)

(73) Assignee: KONE Corporation, Helsinki (FI)

(21) Appl. No.: 18/886,600

(22) Filed: Sep. 16, 2024

(30) Foreign Application Priority Data
Oct. 26, 2023 (EP) 23206101.0

(51) Int. Cl. B66B 5/02; B66B 5/00

(52) U.S. Cl. CPC B66B 5/02; B66B 5/0031

(57) ABSTRACT

An elevator safety system includes a safety controller in connection with an elevator safety chain for monitoring safety of an elevator system. The elevator safety system is arranged, in a first configuration of the elevator safety system, to monitor a set of safety devices, and arranged to be reconfigured from the first configuration to a second configuration of the elevator safety system in response to a detection of a malfunction or failure in a portion of the first configuration, wherein, in the second configuration, the malfunctioned or failed portion is at least functionally excluded. An elevator system and a method for continuing operation of an elevator system after a malfunction or failure are also disclosed.

### FIELD OF THE INVENTION

The present invention relates in general to safety systems of elevators. In particular, however not exclusively, the present invention concerns elevator safety systems comprises a safety controller in connection with an elevator safety chain for monitoring safety of an elevator system.

### BACKGROUND

Traditional elevators are provided with a safety system, also referred to as an elevator safety chain. It may have plurality of safety contacts, such as landing door contacts and final limit switches connected, at least functionally, in series with each other. Opening of a safety contact usually indicates a safety risk causing safety shutdown of the elevator. This means that elevator safety brakes, such as motor brakes, are engaged and use of the hoisting motor is prevented.

This kind of solution is error-sensitive in a way that a single error or failure in the safety chain leads to immediate stopping of an elevator car. It follows that in the case the elevator car has stopped between landing floors, the elevator users will be left in the car until a serviceman arrives at elevator site to release them. This may take some time and it is inconvenient for the users trapped inside the car.

Patent document EP 4074641 A1 shows a safety control device for an elevator. It has two safety control channels which are controlled by two microcontrollers. The safety control device has also an additional override processor that monitors health of said two microprocessors. In case of a single-microcontroller failure, the additional processor overrides the safety control channel of the failed microcontroller so that elevator operation can continue. The additional processor, however, increases overall system complexity and cost.

### SUMMARY

An objective of the present invention is to provide an elevator safety system, an elevator system, and a method for continuing operation of an elevator system after a malfunction or failure. Another objective of the present invention is that the elevator safety system, the elevator system, and the method allow the operation of the elevator to continue, such that users can be released from the car, even in case of failure of an elevator safety chain. The solution may be implemented without adding extra components to the elevator safety chain.

The objectives of the invention are reached by an elevator safety system, an elevator system, and a method for continuing operation of an elevator system after a malfunction or failure as defined by the respective independent claims.

According to a first aspect, an elevator safety system is provided. The elevator safety system comprises a safety controller in connection with an elevator safety chain for monitoring safety of an elevator system.

The elevator safety system is arranged, in a first configuration of the elevator safety system, to monitor a set of safety devices, and arranged to be reconfigured from the first configuration to a second configuration of the elevator safety system in response to a detection of a malfunction or failure in a portion of the first configuration, wherein, in the second configuration, the malfunctioned or failed portion is at least functionally excluded.

In some embodiments, said first configuration may consist of components and devices, which all actively contribute to monitoring elevator safety during normal elevator operation. In other words, said first configuration may not have any “extra safety components”, which would be idle during the normal operation and only introduced in case of an operational anomaly. Said first configuration may thus consists of a subset of components and devices used during the normal operation.

The second configuration may, in view of the safety devices, preferably, include only a subset of the set of safety devices of the first configuration. Thus, the number of safety devices in the second configuration may be smaller, at least by one (by the malfunctioned or failed portion), however, could be by two or more in some cases, than the number of safety devices in the first configuration.

In various embodiments, the first configuration is configured to be utilized during a normal operating condition of the elevator system.

Optionally, the elevator safety system is configured so that in case of the detection of the malfunction or failure being in one in the set of safety devices, the malfunctioned or failed safety device is excluded from the elevator safety chain in the second configuration.

The second configuration is, preferably, configured to be utilized during a limited operating condition of the elevator system. Optionally, the limited operating condition is a short-term operation or a single-time operation of the elevator system.

The safety controller may comprise at least two processing units, respectively in connection with the elevator safety chain. Optionally, the elevator safety system is configured so that in case of the detection of the malfunction or failure being in one of the at least two processing units, at least one other of at least two processing units is used in the second configuration while at least functionally excluding the malfunctioned or failed processing unit.

The safety device or devices may have a functionally duplicated, that is redundant, two-channel structure, such that a single-channel failure of the safety device will not render the safety device inoperative. Two-channel structure enables reduced, short-term operation even in case of a single-channel failure. Two-channel structure means dual processing structure. It may also include, for example, duplicated sensors and duplicated communication channels.

According to a second aspect, an elevator system is provided. The elevator system comprises a plurality of elevator devices and an elevator safety system in accordance with the first aspect or any embodiment thereof. Furthermore, the set of safety devices of the elevator safety system are respectively at least functionally in connection with the plurality of elevator devices.

The plurality of elevator devices may comprise at least one, such as one or two, of: a motor controller and an elevator brake.

The set of safety devices may comprise at least one, such as any one, any two, or all three, of: a safety contact, a safety sensor, a safety switch.

According to a third aspect, a method for continuing operation of an elevator system after a malfunction or failure is provided. The method comprises monitoring, by a safety controller, a set of safety devices of the elevator safety chain in a first configuration of an elevator safety system, detecting the malfunction or failure in a portion of the first configuration, reconfiguring the elevator safety system from the first configuration to a second configuration of the elevator safety system, wherein, in the second configuration, the malfunctioned or failed portion is at least functionally excluded, and continuing the operation of the elevator system by using the second configuration.

Th method may comprise, in case of the detection of the malfunction or failure being in one of at least two processing units of the safety controller, utilizing at least one other of at least two processing units in the second configuration while at least functionally excluding the malfunctioned or failed processing unit.

Alternatively on in addition, the method may comprise, in case of the detection of the malfunction or failure being in one in the set of safety devices, such as in a safety sensor, reconfiguring the elevator safety chain so that the malfunctioned or failed safety device, in a non-limiting example case, said safety sensor, is excluded from the elevator safety chain in the second configuration.

The method may, preferably, comprise utilizing the first configuration during a normal operating condition of the elevator system.

The method may, preferably, comprise utilizing the second configuration during a limited operating condition of the elevator system. Optionally, the limited operating condition is a short-term operation or a single-time operation of the elevator system.

The present invention provides an elevator safety system, an elevator system, and a method for continuing operation of an elevator system after a malfunction or failure. The present invention provides advantages over known solutions in that entrapment of users in an elevator car is avoided since, in cases of an operational anomaly, malfunction or fault/failure, the elevator car can be automatically stopped at a landing floor to release the users.

Various other advantages will become clear to a skilled person based on the following detailed description.

The expression “a number of” may herein refer to any positive integer starting from one (1).

The expression “a plurality of” may refer to any positive integer starting from two (2), respectively.

The terms “first”, “second” etc. are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended patent claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIG. 1 illustrates schematically an example of an elevator safety system in a first configuration.

FIG. 2 illustrates schematically an example of an elevator safety system in a second configuration.

FIG. 3 illustrates schematically an elevator system.

FIG. 4 shows a flow diagram of a method.

### DETAILED DESCRIPTION OF SOME EMBODIMENTS

The elevator safety system in accordance with various embodiments comprises a safety controller in connection with an elevator safety chain for monitoring safety of an elevator system. The elevator safety system is arranged, in a first configuration of the elevator safety system, to monitor a set of safety devices, and arranged to be reconfigured from the first configuration to a second configuration of the elevator safety system in response to a detection of a malfunction or failure in a portion of the first configuration, wherein, in the second configuration, the malfunctioned or failed portion is at least functionally excluded.

The second configuration may, in view of the safety devices, preferably, include only a subset of the set of safety devices of the first configuration. Thus, the number of safety devices in the second configuration may be smaller, at least by one (by the malfunctioned or failed portion), however, could be by two or more in some cases, than the number of safety devices in the first configuration.

The second configuration may, thus, have a simplified structure and it may provide a limited operation only, for example, a short-term operation or a single-time operation of the elevator system. This limited operation may be a consequence of the fact that the simplified structure of the second configuration means higher probability of failure.

The first and the second configurations may be implemented by using at least partially the same components. Preferably, the second safety function is implemented by using the intact components of the first configuration.

In various embodiments, the first configuration is configured to be utilized during a normal operating condition of the elevator system.

Optionally, the elevator safety system is configured so that in case of the detection of the malfunction or failure being one in the set of safety devices, the malfunctioned or failed safety device is excluded from the elevator safety chain in the second configuration.

The safety controller may comprise at least two processing units, respectively in connection with the elevator safety chain. Optionally, the elevator safety system is configured so that in case of the detection of the malfunction or failure being in one of the at least two processing units, at least one other of at least two processing units is used in the second configuration while at least functionally excluding the malfunctioned or failed processing unit.

The safety device or devices may have a functionally duplicated, that is redundant, two-channel structure, such that a single-channel failure of the safety device will not render the safety device inoperative. Two-channel structure enables reduced, short-term operation even in case of a single-channel failure. Two-channel structure means dual processing structure. It may also include, for example, duplicated sensors and duplicated communication channels.

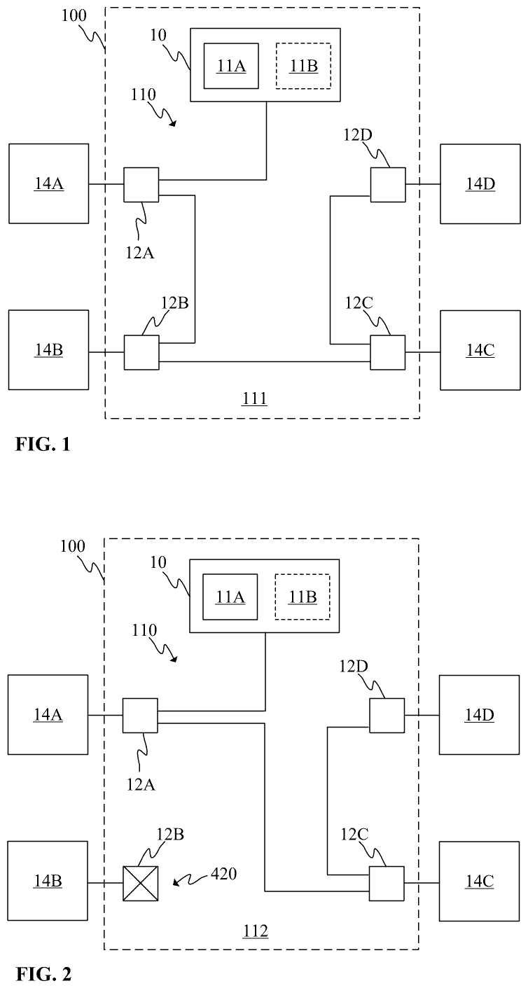

FIGS. 1 and 2 illustrate schematically examples of an elevator safety system 100 in a first configuration 111 and a second configuration 112, respectively. FIG. 1 illustrates the elevator safety system 100 comprising a safety controller 10 in connection with an elevator safety chain 110 for monitoring safety of an elevator system. The elevator safety system 100 is arranged, in a first configuration 111 of the elevator safety system 100, to monitor a set of safety devices 12A-12D, in this particular case four. The set of safety devices 12A-12D may comprise at least one, such as any one, any two, or all three, of: a safety contact, a safety sensor, a safety switch.

The lines in FIGS. 1 and 2 connecting the set of safety devices 12A-12D together represent the at least functional, if not galvanic and/or electrical, series connection of the elevator safety chain 110. As understandable based on FIGS. 1 and 2, if a malfunction or failure occurs in safety device 12B, the elevator safety chain 110 would become broken and/or discontinuous. FIG. 2 illustrates, thus, one example where the malfunctioned or failed portion, that is safety device 12B, is bypassed and the elevator safety chain 110 is reconfigured, in the second configuration 112, to be operable and/or continuous once again. This bypass may be a software-based bypass, done in a safety software of the safety controller 10.

Furthermore, the safety controller 10 and/or the safety devices 12A-12D may have a functionally duplicated, that is redundant, two-channel structure, such that a single-channel failure of the safety controller 10, such as processing unit 11A, 11B thereof, or of the safety device 12A-12D will not render them inoperative. Two-channel structure enables reduced, short-term operation even in case of a single-channel failure. Two-channel structure can mean dual processing structure. It may also include, for example, duplicated sensors and duplicated communication channels, such as a duplicated data bus and/or duplicated messaging.

FIG. 2 illustrates schematically the elevator safety system 100 reconfigured from the first configuration 111 to a second configuration 112 of the elevator safety system 100 in response to a detection 420 of a malfunction or failure in a portion of the first configuration 111, wherein, in the second configuration 112, the malfunctioned or failed portion is at least functionally excluded, as is shown for safety device 12B. The malfunctioned or failed portion, that is the safety device 12B, has been detected to malfunction or fail.

FIGS. 1 and 2 further illustrate a plurality of elevator devices 14A-14D. The plurality of elevator devices 14A-14D may comprise at least one, such as one or two, of: a motor controller, a landing door, a car door, an elevator brake. However, other elevator devices 14A-14D may also be possible.

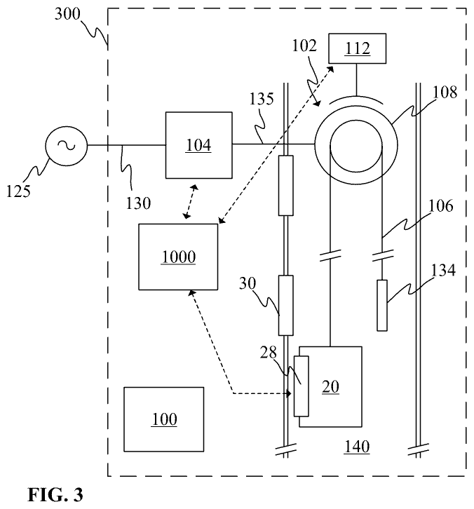

FIG. 3 illustrates schematically an elevator system 300 which may comprise an elevator safety system 100 as described hereinabove. The elevator system 300 may comprise an elevator motion control system 104, such as including an electric converter. The elevator system 300 may comprise an elevator, or “hoisting”, motor 102, such as a permanent magnet electric motor, for moving an elevator car 20 comprised in the elevator system 100. The elevator motor 102 may be arranged to rotate a traction sheave 108. The elevator car 20 may be mechanically coupled to the electric motor 102, preferably, by a hoisting rope 106, for example, extending via the traction sheave 108. The operation of the electric motor 102 may be controlled by the elevator motion control system 104, such as including a frequency converter or an inverter. The elevator car 20 may be moved in and/or along an elevator shaft 140. The elevator car 20 may be moved in a normal operation mode to serve landings or landing floors in accordance with elevator calls. Also shown are the elevator car doors 28 and the landing floor doors 30.

In various embodiments, the elevator car 20 is adapted for transferring passengers and/or cargo between landing floors at least during normal operation of the system 300.

The hoisting rope 106 may comprise, for example, steel or carbon fibers. The term ‘hoisting rope’ does not limit the form of the rope anyhow. For example, the hoisting rope 106 may be implemented as a rope or a belt.

The elevator motor 102 may be arranged in mechanical coupling with a traction sheave 108. Furthermore, the elevator rope 104 may be arranged to run via the traction sheave 108 for the elevator motor 102 to be able to move the elevator car 20 coupled to the hoisting rope 102. Still further, being connected to the hoisting rope 102, may preferably be a counterweight 114 for the elevator car 20. Although shown in FIG. 3 that the hoisting rope 106 would be attached from one end to the elevator car 20 and from the opposite end to the counterweight 114, and then simply running via the traction sheave 108, in practice, the hoisting rope 106 may run via one or several other sheaves and components, and may be terminated at the hoisting rope terminals, as known to a skilled person in the art. Thus, depending how the hoisting rope 106 is arranged to run, for example, past how many sheaves and how such configuration is designed and arranged, the roping ratio may be different from one elevator system 300 to another.

The elevator system 300 may comprise an elevator control unit 1000 for controlling the operation of the elevator system 300, such as various devices thereof. The elevator control unit 1000 may be a separate device or may be comprised in the other components of the elevator system 100 such as in or as a part of the elevator motion control system 104. In various embodiments, the elevator control unit 1000 comprises the elevator motion control system 104.

In some embodiments, the elevator control unit 1000 may comprise the elevator motion control system 104, however, in other embodiments, they may be separate entities, in which case the elevator control unit 1000 may be in communication connection with the elevator motion control system 104, such as providing input signal/data thereto and/or therefrom.

The elevator control unit 1000 may also be implemented in a distributed manner so that, e.g., one portion of the elevator control unit 1000 may be comprised in the elevator motion control system 104 and another portion in the elevator car 20, for instance. The elevator control unit 1000 may also be arranged in distributed manner at more than two locations or in more than two devices. The elevator control unit 1000 may be arranged to at least communicate (examples of such connections being shown with dashed two-headed arrows) with various devices of the elevator system 300.

The elevator system 300 may further comprise an elevator brake arrangement 112 comprising an elevator brake, preferably, an electromechanical elevator brake.

There may be also a main electrical power supply 125 such as a three-phase or single-phase electrical power grid, an electrical connection 130 between the power supply 125 and the elevator motion control system 104, another electrical connection 135 between the elevator motion control system 104 and the electric motor 102.

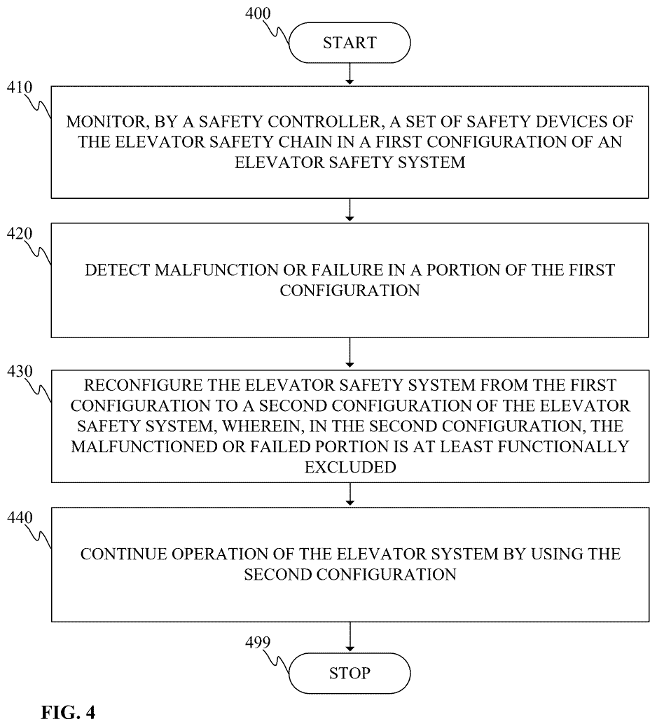

FIG. 4 shows a flow diagram of a method. In various embodiments, the method is for continuing operation of an elevator system after a malfunction or failure. The method steps may, in accordance with a non-limiting example, be performed by the elevator safety system 100, such as by the safety controller 10 thereof.

Item or step 400 refers to a start-up phase of the method. Suitable equipment and components are obtained, and systems assembled and configured for operation.

Item or step 410 refers to monitoring, by the safety controller 10, a set of safety devices 12A-12D of the elevator safety chain in a first configuration 111 of an elevator safety system 100.

Item or step 420 refers to detecting the malfunction or failure in a portion of the first configuration 111.

In some embodiments, the method may comprise, in case of the detection 420 of the malfunction or failure being in one of at least two processing units 11A, 11B of the safety controller 10, utilizing at least one other of at least two processing units 11A, 11B in the second configuration 112 while at least functionally excluding the malfunctioned or failed processing unit. Thus, according to an embodiment, said second configuration 112 may, preferably, be implemented by using the intact components of the first configuration 111 (intact subset).

Alternatively or in addition, the method may comprise, in case of the detection 420 of the malfunction or failure being in one in the set of safety devices 12A-12D, reconfiguring the elevator safety chain so that the malfunctioned or failed safety device 12A-12D is excluded from the elevator safety chain 110 in the second configuration 112.

Item or step 430 refers to reconfiguring the elevator safety system 100 from the first configuration 111 to a second configuration 112 of the elevator safety system, wherein, in the second configuration 112, the malfunctioned or failed portion is at least functionally excluded.

Item or step 440 refers to continuing the operation of the elevator system 300 by using the second configuration 112.

Method execution may be stopped at item or step 499.

Furthermore, the method may comprise utilizing the first configuration 111 during a normal operating condition of the elevator system 300. The normal operation means that there are no faults or such events in the elevator system 300 affecting the functions monitored by the safety chain 110 as was initially set up when configuring the elevator system 300 into use. There may be, during the normal operation, events which may be faults or malfunctions but do not involve safety critical function. For example, there could be a fault in an entertainment system of the elevator system 300 and still the normal operation would be in force since the elevator system 300 can still be used without comprising safety.

Furthermore, the method may comprise utilizing the second configuration 112 during a limited operating condition of the elevator system 300. Furthermore, the limited operating condition may be a short-term operation or a single-time operation of the elevator system 300. For example, there may be a fault at the 7th landing floor detected by the but the safety device(s) thereon, however, an elevator car 20 could still be moved, in the limited operating condition, from the 4^{th} floor to the 1st floor (a single-time operation) or the operation could be continued for some time by serving landing floors between the 1^{st} and the 6^{th} landing floors, and any landing floor therebetween until the elevator is shut down (a short-term operation).

It is also noted herein that while the above describes example embodiments, these should not be viewed in a limiting sense. Rather, there are several variations and modifications, which may be made without departing from the scope of the present disclosure as defined in the appended claims.

The previously presented considerations concerning the various embodiments of the device may be flexibly applied to the embodiments of the method, and vice versa, as being appreciated by a skilled person.

Some advantageous embodiments of the elevator safety system and method according to the invention have been described above. The invention is not limited to the embodiments described above, but the inventive idea can be applied in numerous ways within the scope of the claims. The features recited in dependent claims are mutually freely combinable unless otherwise explicitly stated.

1. An elevator safety system comprising a safety controller in connection with an elevator safety chain for monitoring safety of an elevator system, wherein the elevator safety system is:
arranged, in a first configuration of the elevator safety system, to monitor a set of safety devices; and
arranged to be reconfigured from the first configuration to a second configuration of the elevator safety system in response to a detection of a malfunction or failure in a portion of the first configuration, wherein, in the second configuration, the malfunctioned or failed portion is at least functionally excluded.

2. The elevator safety system of claim 1, wherein the safety controller comprises at least two processing units, respectively in connection with the elevator safety chain.

3. The elevator safety system of claim 2, configured so that in case of the detection of the malfunction or failure being in one of the at least two processing units, at least one other of at least two processing units is used in the second configuration while at least functionally excluding the malfunctioned or failed processing unit.

4. The elevator safety system of claim 1, configured so that in case of the detection of the malfunction or failure being in one of the set of safety devices, the malfunctioned or failed safety device is excluded from the elevator safety chain in the second configuration.

5. The elevator safety system claim 1, wherein the first configuration is configured to be utilized during a normal operating condition of the elevator system.

6. The elevator safety system of claim 1, wherein the second configuration is configured to be utilized during a limited operating condition of the elevator system.

7. The elevator safety system of claim 6, wherein the limited operating condition is a short-term operation or a single-time operation of the elevator system.

8. An elevator system comprising:
a plurality of elevator devices; and
the elevator safety system of claim 1, wherein the set of safety devices of the elevator safety system are respectively at least functionally in connection with the plurality of elevator devices.

9. The elevator system of claim 8, wherein the plurality of elevator devices comprises at least one of a motor controller and an elevator brake.

10. The elevator system of claim 8, wherein the set of safety devices comprises at least one of a safety contact, a safety sensor, a safety switch.

11. A method for continuing operation of an elevator system after a malfunction or failure, the method comprising:
monitoring, by a safety controller, a set of safety devices of an elevator safety chain in a first configuration of an elevator safety system;
detecting the malfunction or failure in a portion of the first configuration;
reconfiguring the elevator safety system from the first configuration to a second configuration of the elevator safety system, wherein, in the second configuration, the malfunctioned or failed portion is at least functionally excluded; and
continuing the operation of the elevator system by using the second configuration.

12. The method of claim 11, comprising, in case of the detection of the malfunction or failure being in one of at least two processing units of the safety controller, utilizing at least one other of at least two processing units in the second configuration while at least functionally excluding the malfunctioned or failed processing unit.

13. The method of claim 11, comprising, in case of the detection of the malfunction or failure being in one in the set of safety devices, reconfiguring the elevator safety chain so that the malfunctioned or failed safety device is excluded from the elevator safety chain in the second configuration.

14. The method of claim 11, comprising utilizing the first configuration during a normal operating condition of the elevator system.

15. The method of claim 11, comprising utilizing the second configuration during a limited operating condition of the elevator system.

16. The method of claim 15, wherein the limited operating condition is a short-term operation or a single-time operation of the elevator system.

17. The elevator safety system of claim 2, configured so that in case of the detection of the malfunction or failure being in one of the set of safety devices, the malfunctioned or failed safety device is excluded from the elevator safety chain in the second configuration.

18. The elevator safety system of claim 2, wherein the first configuration is configured to be utilized during a normal operating condition of the elevator system.

19. The elevator safety system of claim 3, wherein the first configuration is configured to be utilized during a normal operating condition of the elevator system.

20. The elevator safety system of claim 4, wherein the first configuration is configured to be utilized during a normal operating condition of the elevator system.
